(19) United States
(12) Patent Application Publication
(10) Pub. No.: US 2015/0365979 A1
(43) Pub. Date: Dec. 17, 2015

(54) Methods And Apparatus For Intelligent Connection Control And Emergency Assisting With mobile devices

(71) Applicant: SEUNG DUK PARK, SAN DIEGO, CA (US)

(72) Inventor: SEUNG DUK PARK, SAN DIEGO, CA (US)

(21) Appl. No.: 14/301,905

(22) Filed: Jun. 11, 2014

(51) Int. Cl. H04W 76/00; H04W 4/00; H04L 29/08; H04W 4/02

(52) U.S. Cl. CPC H04W 76/007; H04W 4/02; H04W 4/008; H04L 67/12

(57) ABSTRACT

This invention provides smart and convenient Bluetooth enabled and other wireless enabled device connection with car and other type of vehicles with Bluetooth connection feature. A method is recognizing and sensing the presence of Bluetooth enabled mobile devices with other conditions, such as presence of owner in a car, sensing the movement of a mobile device, and door open-close status, and then connect and disconnect intelligently between wirelessly connected mobile devices and said a car kit. For example, Bluetooth profiles, such as HFP, HSP, HID, A2DP, AVRCP, AVDTP, AVCTP, GAVDP, PBAP, PBA, PXP, VDP, SYNCH, and other connection oriented Bluetooth and Bluetooth Low Energy profiles, can utilize the method for convenience and intelligent connection and disconnection.

Other types of wearable devices such as glass, glasses, wristband, necklace, any kind of skin attaching devices sensing bio-information from a user, use this method for convenience connection service by sensing a wearing status, and save power intelligently.

This invention includes more methods working as a car “Black Box” that records messages from ECU, trip computer, sensors, and route information from the start and stop of vehicle. And it is providing emergency call service intelligently based on the algorithms to determine crash impacts and call asking help such as 911, other registered phone numbers automatically and send short message and photo messages automatically to save life and fast service.

### CROSS-REFERENCE TO RELATED APPLICATIONS

Background—Prior Art

None

U.S. Patents

| | | |
|---|---|---|
| Patent Application Number | Date | Patentee |

Nonpatent Literature Documents

None

### BACKGROUND

Many Bluetooth and Bluetooth Smart, IEEE 802.15.x, WiFi, 802.11.x enabled devices are used for wireless speaker, car kit, video player, controller, and other types of wireless devices. Although it provides automatic connection for registered devices by using paring mechanism, disconnection depends on wireless signal disappearing and disconnection request by user without considering more various situations. For example, when driver get out of a car and stay near the car but a Bluetooth car kit still connected with mobile device that is in driver's pocket so that a phone call will be directed to the car kit speaker when have an incoming call. Therefore, it needs more sophisticated, smart connection and disconnection methods to sense the location of mobile device, driver (said user), and door operation.

A vehicle, said a car, and any type of motor driven vehicle such as electric cars, motor cycles, evolved greatly. Although vehicles are used every day, it is relatively less developed for status reporting to prevent sudden breakdown and accident. It is very important issue that automatic accident reporting and asking help in time to save passengers by communicating emergency assistance in a critical accident.

### BRIEF SUMMARY OF THE INVENTION

Methods in this invention can help and provide more intelligent connection and disconnection feature by sensing the presence of user and the movement of mobile devices that are connected to other Bluetooth and any type of wireless connection supporting devices as hosts and peripherals. The methods will cover any kind of profiles of Bluetooth to support connection-oriented service such as HFP, HSP, HID, A2DP, AVRCP, AVDTP, AVCTP, GAVDP, PBAP, PBA, PXP, VDP, and SYNCH with a car infotainment system (a car kit) supporting features but not limited to.

A Bluetooth car kit said car infotainment system that has Bluetooth profiles senses the presence of driver and the movement mobile devices for smart pairing for convenience. Sensors are sensing the driver seat if driver is on the seat, sensing the door operation if door is opened and the status of open to closed and of closed to open, and a proximity profile sense a significant movement of a mobile device that registered and paired with Bluetooth car kit, said car infotainment system. Bluetooth enabled wearable devices, such as glasses, watch, necklace, and health monitor with Bluetooth enabled, sense the status of the wearable devices, and then decide intelligently whether maintain the connection or initiate disconnection.

Other types of wireless connection that provide connection oriented services to other mobile devices can use the same methods in this invention for intelligent connection and disconnection to save any resource such as battery power, radio wave signal bandwidth, but not limited to.

A system in this invention, as a part of a car kit or a car infotainment system, communicates and receives the data from installed sensors and then decides what next action should be done as predetermined conditions, and saves the data into a storage. The system works as black box to record all the status of a vehicle from a trip computer, sensors, ECU, and other monitored equipment, and works as a rescue assistance in case of accident in real time, almost instantly using connection with sensors, car diagnostic computer, ECU, trip computer, GPS system, and a mobile device that connected with by setup call and send short message(SMS) to such as 911, insurance company, police station, and predefined number(s) in an accident.

### BRIEF DESCRIPTION OF THE DRAWINGS

FIG. 1 Diagram with a car kit, sensors, and a mobile device

FIG. 2 When user is out of a car

FIG. 3 Diagram of a car kit, a mobile device, and remote servers for services

FIG. 4 Diagram of operation in case of accident

FIG. 5 Accident automatic assessment and emergency communication

FIG. 6 Wearable device: glass type

FIG. 7 Wearable device: band style

### DETAILED DESCRIPTION

A system and apparatus of this invention described herein are illustrated by way of example and not by way of limitation in the accompanying figures. For simplicity and clarity of illustration, elements illustrated in the figures are not necessarily drawn to scale, shape, and additional features. The meaning of “car kit” or “car infotainment system” or “infotainment console” or “car controller”, or “car infotainment controller” of the invention has a particular feature, structure, or characteristic described in connection with a feature included in at least one of the listed components, such as LCD screen, key pad, touch screen, telephony control, audio, video transmission, and data communication with a mobile device.

The sensors of this invention are include, but not limited to airbag sensor, seat sensor, and any kind of driver and passenger perception sensor that detect driver's and passenger's status in a car, and a car kit menu provides a way to select which mobile device is connected as primarily.

A system in this invention includes at least one communication module to communicate with sensors, trip computer, ECU, GPS, and other parts of a vehicle status monitoring modules. The system communicates and gathering the data from them, and then save and used for the methods of this invention for further applications and services.

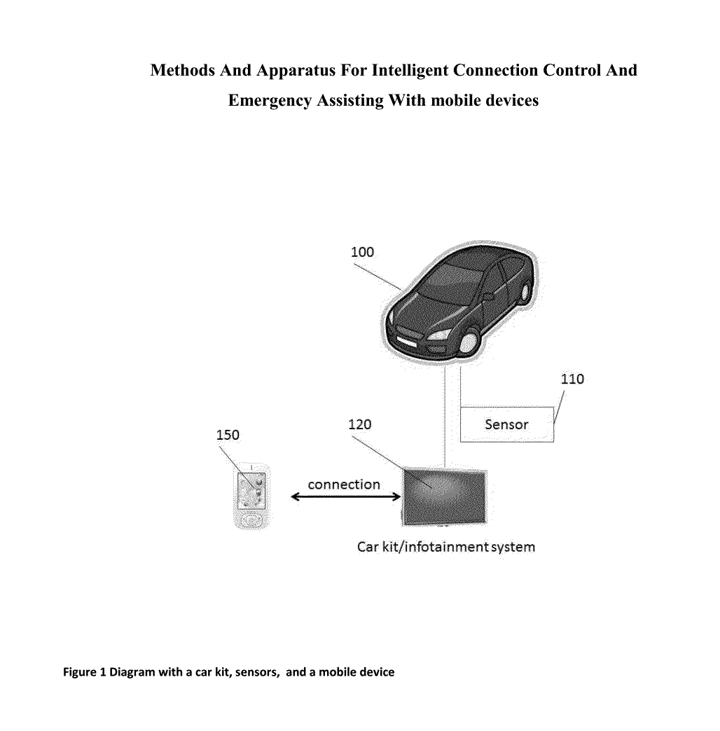

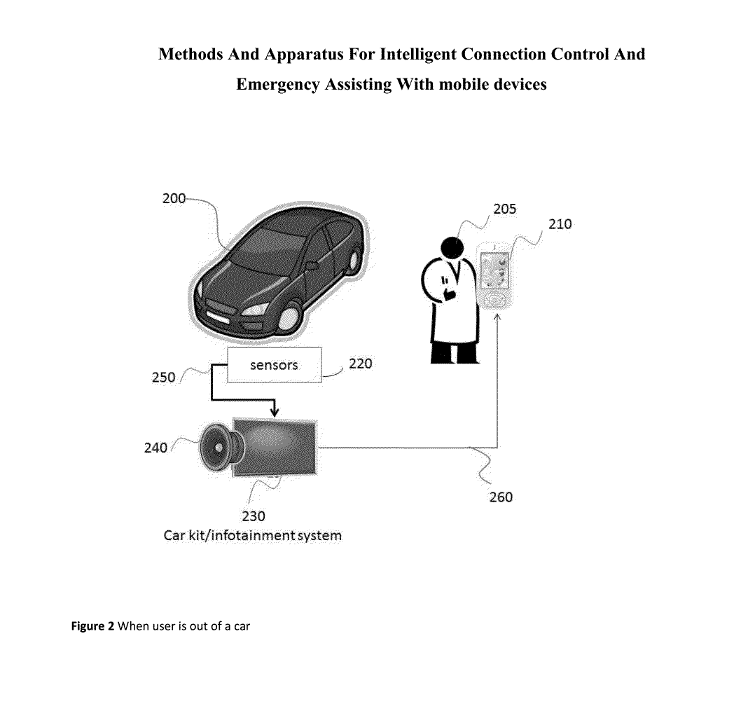

Said a car kit providing Bluetooth and other wireless connection with a mobile device does many things for providing car status, navigation, music, and more value added feature by connecting with a mobile device, such as a cellular phone, a smart phone, a tablet pc, and any types of wearable devices but not limited to. A method in this invention provides smart connection and disconnection between a car kit, said car infotainment system and a mobile device by sensing a driver or a passenger's presence in a car. In FIG. 1, it illustrates that simple system components working with together, a sensor, said car infotainment system, and a mobile device. A car infotainment system, or said car kit connected wirelessly for data communication for the services such as HFP, A2DP, AVDTP, SAP, SMS, PBAS, PBA, SYNCH, PXP, and other Bluetooth profiles, IEEE 802.15.x, but not limited to. In FIG. 1, [120] receives status data from [110] and save and use the data to decide to make connection with [150] in conjunction with the signal strength of between [150] and [120].

[205], a driver or a passenger, holding a mobile device that connected with said a car kit, gets out of the car, [220] senses the presence of people if user stays in a seat and update the car kit with the information of [205]'s status. [250] indicates that the status data from sensors such as seat sensor, door sensor, and other passenger perception sensors, transfers to said a car kit system via the part of the system of this invention for data communication. [230], said a car kit, and also monitoring the movement of the mobile device [210], using radio signal strength, for example, using the proximity profile of Bluetooth specification but not limited to Bluetooth radio wave signal, and then decide if the mobile device is out of car, and [230] initiate disconnect request, [260] in FIG. 2, to the mobile device when the mobile device out of car with driver, passenger who has the mobile device. Although, for example, Bluetooth radio signal is strong enough to reach out of the car based on Bluetooth class specification to the mobile device, [230] can initiate disconnect request and process following operations to save status, synchronizing information, and applications but not limited to. Therefore, even though they are close enough to reach the car kit wirelessly, user can use phone conveniently without pressing and selecting disconnect Bluetooth car kit or redirecting, and user can get other controls back to phone from [230] when mobile and user stay outside of car.

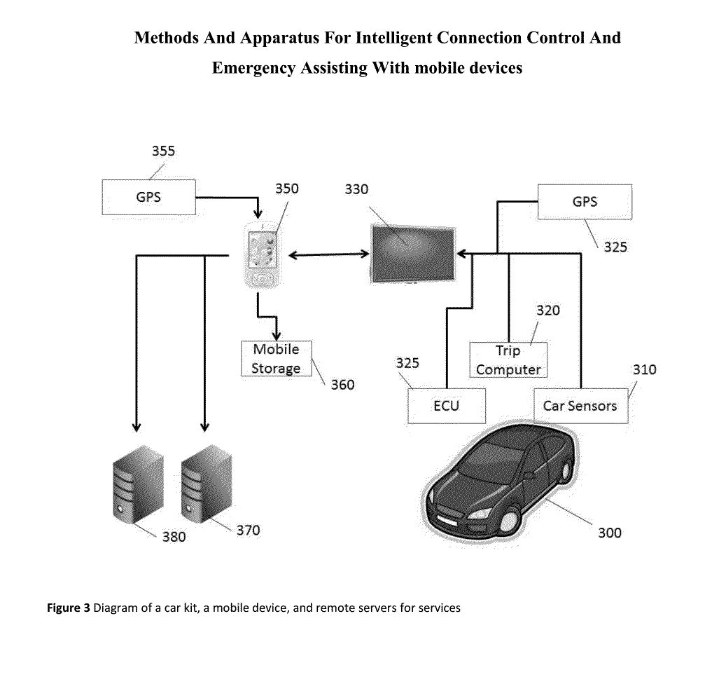

In FIG. 3, [350] connected with [330], said a car kit, communicates and synchronizes the data received from a car trip computer, diagnosis system, ECU (engine control unit), and GPS system. A Car kit, trip computer, and said ECU have its own functions but separately managed. However, these systems will be connected and communicate with each other to receive data and status update for better service and maintenance for a car, and then [350], such as mobile phone, tablet, and any kind of mobile device that connected with [330] will provide wireless communication and additional services such as tracking the route, location based service, roadside assistance, maintenance advice, advertisements, black box to keep record of all status, but not limited to. For example, when a car turns on check engine light, OBD-II PIDs (On-board diagnostics Parameter IDs) transfer to a mobile device connected and provide more detail information to the driver with explanation of the OBD-II PIDs, and then automatically connect to car maintenance service or insurance for roadside assistance immediately for safety, fast service, and also find closest maintenance shop to get service when necessary with and without driver's action. The OBD-II PIDs will be stored into the servers [380], [370] for further additional services automatically in conjunction with vehicle status data, time, routes from trip computer and GPS system. In case of the servers are not connected via internet or wireless network, [350] saves all synchronized data from [330] in its storage [360], and then will update the server when it connected. [330] also the first place to save all data from a vehicle into its own storage memory. [325] provides GPS location, route information, road number, and address, but if there is no in-car GPS system, [355] in a mobile device will do the same role.

Servers not only save the data from a vehicle but also will use them for further methods, for example, such as best route suggestion to save time, battery, and gas in conjunction with traffic information, advertisement, and other services based on the location and route. For example, real time traffic information and a route suggestion to a destination is updated from the mobile device to a car kit route system to displace a real time traffic information.

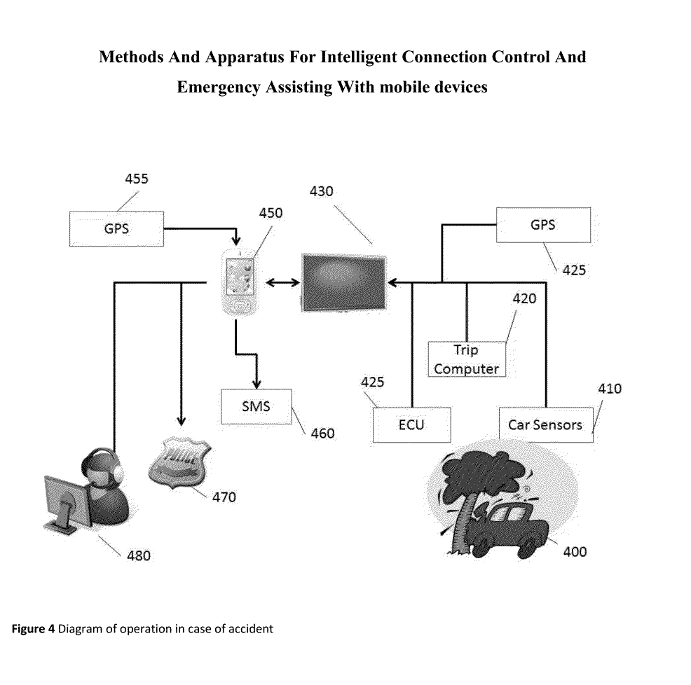

A mobile device, in FIG. 4, connected with said a car kit and said a car infotainment system will work as emergency communication system and black box that keep saving data of both accident and all status data. [410] such as air bag deployment sensors, an accelerometer like multi-axis accelerometer, seat belt sensors, and any safety related sensors in a car detects an accident and then have a car kit works as emergency communication system in conjunction with the mobile device connected. [430] with a system described in this invention connected with car sensors and a car computer continually monitoring the status of the car, and when accident happened, [430] gathers and use accident related data to find out how serious accident it is, such as air bag deployment, number of passengers, value of accelerometer, cabin temperature, cabin smog detection, but not limited to, and the location of accident from GPS system. [430] calculate and decide accident levels with predetermined condition, and initiate call setup request using Bluetooth profiles to [480], 911 call center, and insurance company for roadside assistance [470], near police station, and send short message via short message service [460] to the registered number based on the number and message related settings. If there is no GPS system in a car, the car kit does not provide GPS location but the mobile device connected uses its own GPS data as a backup and also using the data for accident reporting.

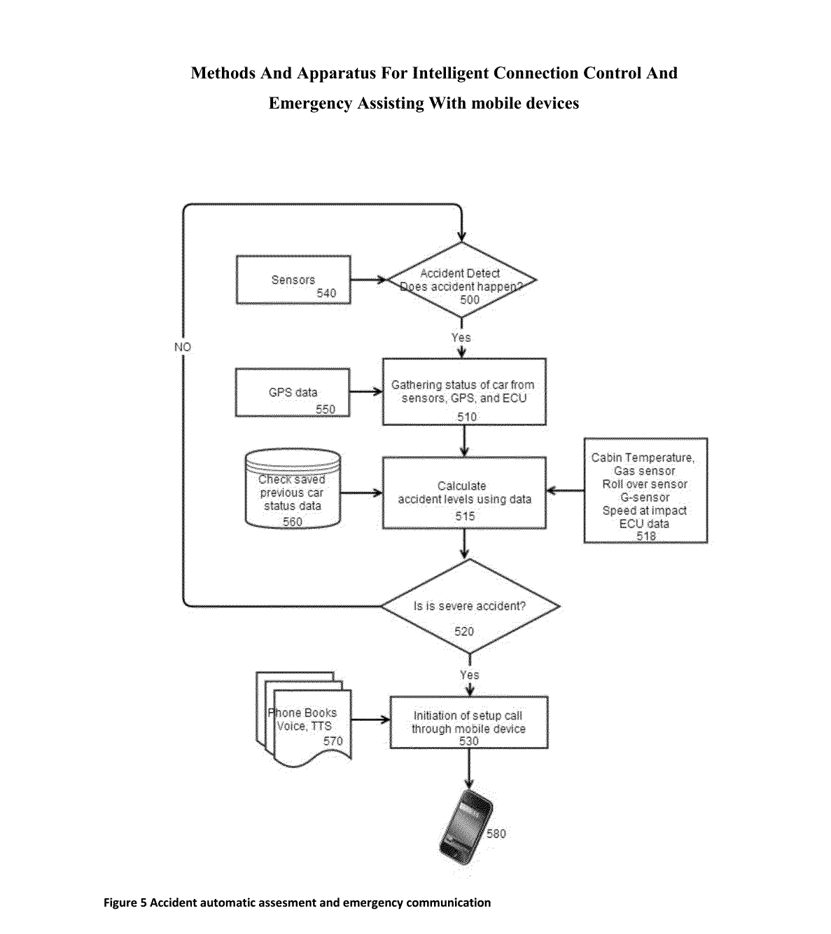

FIG. 5 shows the sequence and block diagram, when accident detected [500], it automatically gathering or receiving data [510] from sensors, GPS, trip computer, ECU, and then [515] determine the impact of the accident with the gathered data and then search phone books [570] for emergency contacts, if saved, to initiate emergency call to help automatically. If the phone book does not have emergency contact numbers, the mobile device search the number in that region automatically because emergency phone number may vary based on the countries, regions, geo-locations. This method has a feature for recorded voice and text-to-speech to ask help with accident status report in case of driver and passengers are not in state to talk. A software in the mobile device connected automatically turn on speaker phone to talk effectively.

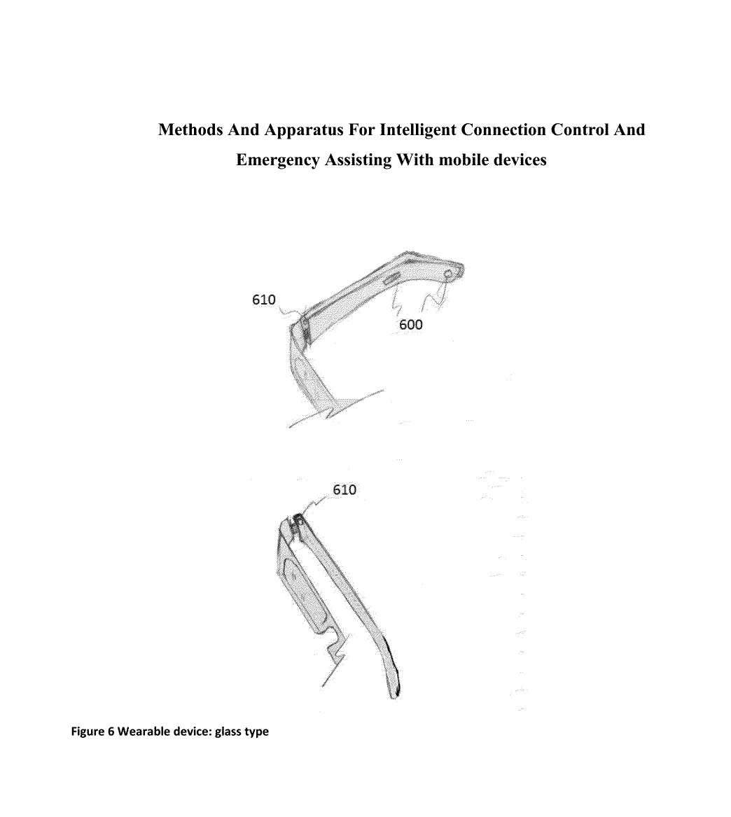

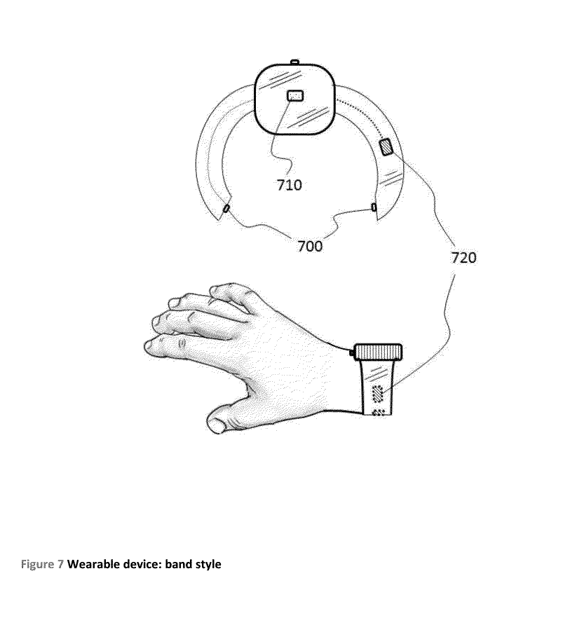

A method in this invention are also applied to the any type of wearable devices, such as glass, glasses, wrist watch, necklace, bracelet, but not limited to, that contact skin of people and animal pet that have wearable devices to get any type of bio-data including temperature, pulse, oxygen level in blood, but not limited to. The method can detect the status if user wears a device using a temperature sensor, a contact sensor, a oxygen sensor in conjunction with or solely and then connected with a power control unit of device to initiate connect and disconnect with a mobile device to save battery power and unwanted operation when it does not need to work. In FIG. 6, for example, a sensor installed inside of hinge [610] and a sensor [600] installed in a leg part that contact to skin, the position of sensor may vary to contact skin effectively. [610] senses the status of whether a wearable device having hinge part is opened or closed, and [600] embedded in a glass leg part senses the skin contact using many technologies such as pressure sensing, resistive method, capacitive method, infrared method, dispersive signal method, thermal sensing method, but not limited to. In conjunction with these sensing technologies, the device recognize if it is worn so the device initiate connection and disconnection intelligently with host mobile devices and other host devices. As it is shown in FIG. 7, this method in this invention can be utilized to any other types of wearable devices having band, leg, any skin attaching parts, for example, wrist watch, and necklace. Embedded sensors in wearable devices sense the status of skin contact, temperature, band lock and then use it as same way as described above. For example, band lock and other sensors provide the status information to the operating system and application of the wearable device to control power related operation and wireless connection, disconnection operation.

### REFERENCES (INCORPORATED HEREIN BY REFERENCE)

On-board diagnostics (OBD) is an automotive term referring to a vehicle's self-diagnostic and reporting capability. OBD systems give the vehicle owner or repair technician access to the status of the various vehicle sub-systems. The amount of diagnostic information available via OBD has varied widely since its introduction in the early 1980s′ versions of on-board vehicle computers. Early versions of OBD would simply illuminate a malfunction indicator light or “idiot light” if a problem was detected but would not provide any information as to the nature of the problem. Modern OBD implementations use a standardized digital communications port to provide real-time data in addition to a standardized series of diagnostic trouble codes, or DTCs, which allow one to rapidly identify and remedy malfunctions within the vehicle.

OBD-II PIDs (On-board diagnostics Parameter IDs) are codes used to request data from a vehicle, used as a diagnostic tool.

In automotive electronics, electronic control unit (ECU) is a generic term for any embedded system that controls one or more of the electrical system or subsystems in a motor vehicle. Types of ECU include electronic/engine control module (ECM), powertrain control module (PCM), transmission control module (TCM), brake control module (BCM or EBCM), central control module (CCM), central timing module (CTM), general electronic module (GEM), body control module (BCM), suspension control module (SCM), control unit, or control module. Taken together, these systems are sometimes referred to as the car's computer. (Technically there is no single computer but multiple ones.) Sometimes one assembly incorporates several of the individual control modules (PCM is often both engine and transmission)^{[1]}

What is claimed are:

1. A system comprising:
receiving data from a car including installed sensors, trip computer, and ECU of vehicle;
storage, including volatile and non-volatile memory, to save received data from sensors, trip computer, and ECU for tracking history with time stamp;
connecting part to transferring signals and values from sensors, trip computer, and ECU herein, ether wireless and wired connection;

2. A method comprising:
a database and data structure consisted of time stamp, sensors' values, ECU message, either ECU message comes up and regular checking message, the data from a trip computer such as speed, direction but not limited to, and a link to GPS data;
calculating and determining the level of accident based on the data from sensors, trip computer, and ECU with predetermined accident values;
connecting and disconnecting with a mobile device based on sensor values and a mobile device movement, and user status if he/she in or out of vehicle;

3. A methods comprising:
transferring and synchronizing the gathered data to a mobile device that is connected with said a car kit to maintain same data in its mobile storage;
backuping synchronized data to a remote server by connecting wired or wireless network for further via either a connected mobile device and connected WiFi directly without a mobile device connection;
using the GPS data from a mobile device when said a car kit does not provide GPS information, and linking the GPS data with other data from a car;

4. A method comprising;
storing and searching reserved said phone book or said contact entity for emergency call, short text and multimedia messages;
searching and updating an emergency call numbers into said phonebook or said contact entities based on the countries, regions, geographical location of a vehicle, and synchronizing the numbers between said a car kit and the mobile device connected;
using pre-recorded voice and message, when people cannot speak clearly, in conjunction with computer aided speech, said text to speech, regarding GPS location, road number, car status, accident level information, and number of passengers but not limited to when a call connected to the emergency service number;
composing and sending pre-determined text message with GPS location, road number, car status, accident level information, and number of passengers but not limited to, when sending a text or multimedia message the emergency service number;
composing audio, picture, and video message using a mobile phone or installed camera, mic in a car automatically when accident happened and updating the status;
initiating phone call and initiate phone message to send said the emergency numbers and pre-define numbers via a mobile device connected and other communication channel installed in said a car kit;

5. A method comprising:
invoking, by a wearable device, and send message a power control module by sensing if a wearable device is worn using installed sensors;
initiating, by a wearable device, disconnect and connect request using the status of whether a wearable device is worn or not;
